(19) United States
(12) Patent Application Publication
(10) Pub. No.: US 2018/0198537 A1
(43) Pub. Date: Jul. 12, 2018

(54) Technique For Calibrating An Antenna Array

(71) Applicant: Telefonaktiebolaget LM Ericsson (publ), Stockholm (SE)

(72) Inventors: Leonard Rexberg, Hässelby (SE); Bernt Johansson, Värmdö (SE); Jan-Erik Thillberg, Stockholm (SE)

(21) Appl. No.: 15/740,536

(22) PCT Filed: Jul. 1, 2015
(86) PCT No.: PCT/EP2015/065035

§ 371 Date: Dec. 28, 2017

(51) Int. Cl. H04B 17/12; H01Q 3/26; H04B 17/14

(52) U.S. Cl. CPC H04B 17/12; H01Q 1/243; H04B 17/14; H01Q 3/267

(57) ABSTRACT

A technique for calibrating an antenna array (300) is described. The antenna array (300) includes a plurality of antenna elements (302). As to a method aspect of the technique, at least a first antenna element and a second antenna element are configured for a first operating mode. At least a third antenna element is configured for a second operating mode. The first operating mode includes transmission and the second operating mode includes reception, or vice versa. A first signal transfer between the first antenna element and the third antenna element as well as a second signal transfer between the second antenna element and the third antenna element are measured. A ratio based is determined on the first signal transfer measurement and the second signal transfer measurement. The antenna array (300) is calibrated based on the determined ratio.

### TECHNICAL FIELD

The present disclosure generally relates to antenna arrays. More specifically, a method and a device are provided for calibrating an antenna array including a plurality of antenna elements.

### BACKGROUND

Antenna arrays are used for providing higher data rates to more wirelessly connected user equipments and embedded devices, and for a more robust radio link. For in-stance, the antenna arrays implemented at base stations of a mobile communications network enable beamforming and Multiple-Input Multiple-Output (MIMO) channels. For MIMO communication, a plurality of antenna elements forming an antenna array is also implemented at the user equipments, the embedded devices or on either sides of a backhaul link in the mobile communications network.

The directional gain of an antenna array can be significantly greater than conventional antenna gains, which enables higher carrier frequencies by compensating path loss. Thus, antenna arrays expand the resources available for wireless communication in terms of frequency and spatial layers.

Many of the codebook entries defining MIMO radiation patterns inherently assume that the antenna array is calibrated, i.e., each radio branch in both transmit and receive direction is balanced in phase and amplitude, and possibly also time delay, in such a way that a proper antenna array beam can be formed with a well-defined main beam pointing in a predefined direction.

Existing approaches for calibrating an antenna array can mainly be divided into two groups, one of which requires additional hardware. For example, external analog radio frequency equipment is required for determining a transmission characteristic and mapping a reception characteristic of the antenna array. The other group of existing calibration techniques involves both sides of an active bidirectional communication, wherein the peer of the communication provides a feedback signal.

Moreover, document US 2005/0143014 A1 discusses an internal calibration based on ratios associated with pairs of two different antenna elements. As a consequence, the number of measurements scales quadratically with the number of antenna elements. Furthermore, each ratio depends on four gain factors associated with a transmit chain gain and a receive chain gain for each of the two antenna elements.

### SUMMARY

Accordingly, there is a need for a technique that enables an efficient stand-alone calibration of an antenna array.

As to one aspect, a method of calibrating an antenna array including a plurality of antenna elements is provided. The method comprises the step of configuring at least a first antenna element and a second antenna element for a first operating mode, and configuring at least a third antenna element for a second operating mode, wherein the first operating mode includes transmission and the second operating mode includes reception or vice versa; the step of measuring a first signal transfer between the first antenna element and the third antenna element, and measuring a second signal transfer between the second antenna element and the third antenna element; the step of determining a ratio based on the first signal transfer measurement and the second signal transfer measurement; and the step of calibrating the antenna array based on the determined ratio.

The determined ratio may be representative of a ratio between a first gain associated with the first antenna element and a second gain associated with the second antenna element. E.g., the ratio may be representative of a relationship or relative state between the first and second antenna elements and/or any components or radio branches associated with these antenna elements, respectively. For example, the expression “antenna element” may encompass (or may be interpreted as an abbreviation of) an “antenna element radio branch”. The configuring and/or the calibrating may be applied to any component associated with the respective antenna element. The configuring and/or the calibrating may be applied only to the radio branches or components thereof. Moreover, each of the expressions “first antenna element”, “second antenna element” and “third antenna element” may encompass and/or may specify “a first antenna port”, “a second antenna port” and “a third antenna port”, respectively. The respective antenna port may be an antenna transmit port or an antenna receive port, e.g., according to the respectively configured operating mode.

The expression “antenna array” may encompass (or may be interpreted as an abbreviation of) an “antenna array system” and/or a “radio branch array”. The antenna array and/or the radio branch array may further include a plurality of radio branches. Each of the plurality of antenna elements may be associated with at least one of the radio branches.

The components associated with at least one of the antenna elements may include any radio component of an antenna radio branch (or the entire antenna radio branch), e.g., a power amplifier, a low noise amplifier, an analog-to-digital converter, a digital-to-analog converter, a transmission side-branch, a reception side-branch, an antenna switch and/or a side-branch switch, etc.

The technique is applicable to a multi-branch system. Embodiments can calibrate a multitude of radio branches for the antenna elements of the antenna array, e.g., relative to each other.

The ratio may be indicative of a deviation between characteristics of the first antenna element (or the one or more components associated with the first antenna element) and characteristics of the second antenna element (or the one or more components associated with the second antenna element).

The calibration method may be controlled, e.g., by repeating at least the measuring step and the determining step, so that the deviation is minimized. The calibration method may be triggered periodically and/or by an event. A triggering periodicity may be equal to, or on the order of, 10 minutes, 1 hour, few hours or a day. A triggering event may include a radio quality criterion, e.g., if the radio quality falls below a threshold. The deviation may be caused by aging (e.g., aging of the associated component) and/or a drift in temperature.

The third antenna element (or the corresponding antenna port) in the antenna array may function as a measuring partner for any other antenna element (or the corresponding antenna ports) in the antenna array, e.g., for the first and second antenna elements. By determining the ratio, an influence of the third antenna element and/or any other component associated with the third antenna element can be substantially eliminated so that the ratio may be representative of the relationship between the first and second antenna elements in at least some embodiments.

A single receiving antenna element (or receive branch) or a single transmitting antenna element (or transmit branch) may be used as the measuring partner (i.e., as the third antenna element) for measuring the signal transfer involving any other antenna element or radio branch (i.e., as the first or second antenna element or respectively associated radio branch). Particularly, embodiments can calibrate all transmitting antenna elements or transmit side-branches and/or all receiving antenna elements or receive side-branches with less additional hardware and/or without external hardware.

Other antenna elements or radio branches (e.g., all antenna elements of the antenna array that are not involved in the signal transfer measurement) may be isolated or in an inoperative state, e.g., as a result of the configuring step. E.g., each of the other antenna elements or radio branches may be in a muted state, a grounded state and/or a high-impedance state during the signal transfer measurement.

The second antenna element (or the associated radio branch) may be in an inoperative state during the measurement of the first signal transfer. Alternatively or in addition, the first antenna element (or the associated radio branch) may be in the inoperative state during the measurement of the second signal transfer. All further antenna elements (or the associated radio branches) of the antenna array may be in the inoperative state during the measurement. The inoperative state may include the muted state, the grounded state and/or the high-impedance state.

The signal transfer measurements may be performed for each of the plurality of antenna elements (or the associated radio branches). Each of the plurality of antenna elements (or the associated radio branches) may function at least once as the first antenna element (or the associated radio branch) or as the second antenna element (or the associated radio branch).

The signal transfer measurements may be performed by traversing the plurality of antenna elements (or the associated radio branches) according to a predefined scheme or in a loop. The plurality of antenna elements (or the associated radio branches) may be traversed so that each antenna element (or the associated radio branch) functions once as the first antenna element (or the associated radio branch). The number of signal transfer measurements performed, or necessary, for calibrating the entire antenna array may be substantially proportional to, or may scale linearly with, the number of the plurality of antenna elements (or the associated radio branches).

The second antenna element may be selected for the measurement as a function of the first antenna element. The second antenna element may be a neighboring antenna element, e.g., the previous first antenna element or the next first antenna element according to the scheme or the loop.

The first signal transfer measurement and the second signal transfer measurement may be performed subsequently. Alternatively or in addition, the configuration of the second antenna element and/or the second signal transfer measurement may be performed after completion of the configuration and the measurement involving the first antenna element.

The third antenna element may be selected independently of the first and second antenna elements. E.g., the same antenna element may be used as the third antenna element for all or a certain portion of the signal transfer measurements. Alternatively, the plurality of antenna elements of the antenna array may be logically partitioned in sections. One antenna element may be associated with each section to function as the third antenna element if the first second antenna element and/or the second antenna element are in the associated section.

Alternatively or in addition, the second antenna element (and optionally the third antenna element) may be adjacent to the first antenna element in the antenna array for each signal transfer measurement.

The antenna array may be coupled to a transceiver for Time Division Duplex (TDD) communication. The signal transfer measurements may include scheduling transmission and reception for the same time, e.g., for a time specific for each of the first and second signal transfer measurements.

Alternatively or in addition, the antenna array may be coupled to a transceiver for Frequency Division Duplex (FDD) communication. The signal transfer measurements may include tuning transmission and reception to the same frequency, e.g., to the same carrier or sub-carrier frequency.

A power for the transmission in the signal transfer measurements may be significantly less than, e.g., a fraction of, a transmit power used for a regular bidirectional communication, e.g., for the duplex communication. The power for the measurement may be less than half of the transmit power for the duplex communication.

An antenna branch associated with the third antenna element may be available for operation in the second operating mode independently of operating antenna branches associated with the first and second antenna elements (or any other antenna element, e.g., including the third antenna element) in the first operating mode. The first and second antenna elements may be configured for a first polarization. The third antenna element may be configured for a second polarization that is different from the first polarization.

The determination of the ratio may be a function of a first radio frequency coupling between the first and third antenna elements, and on a second radio frequency coupling between the second and third antenna elements. The first and second radio frequency couplings may be known. Values for the first and second radio frequency couplings may be retrieved from memory. The memory may be collocated with the antenna array.

Each signal transfer measurement may include transmitting a reference signal by the antenna element configured for transmission. If the second operating mode includes the transmission (i.e., for a transmitting third antenna element), the first and second signal transfer measurement may be performed simultaneously.

Each signal transfer measurement may include receiving the reference signal by the antenna element configured for reception. If the first operating mode includes the reception (i.e., for receiving first and second antenna elements), the first and second signal transfer measurement may be performed simultaneously.

Each signal transfer measurement may include correlating the transmitted reference signal and the received reference signal. The ratio may be determined according to

$$\frac{{S}_{23}}{{S}_{13}} \cdot \frac{{c}_{1}}{{c}_{2}} ,$$

wherein S₁₃ is representative of the first radio frequency coupling, S₂₃ is representative of the second radio frequency coupling, c₁ results from the correlation of the first signal transfer measurement, and c₂ results from the correlation of the second signal transfer measurement. The ratio may be equal to

$$\frac{{g}_{1}}{{g}_{2}} = \frac{{S}_{23}}{{S}_{13}} \cdot \frac{{c}_{1}}{{c}_{2}} ,$$

wherein g₁ is representative of the first gain, and g₂ is representative of the second gain

The absolute gains g₁ and g₂ are not necessarily relevant for the calibration. The calibration can be based (e.g., to the extent that the gains associated with the antenna elements are concerned) solely based on the ratio g₁/g₂. The ratio may merely represent a complex ratio between a radio branch associated with the first antenna element and a radio branch associated with the second antenna element. The third antenna may be used only to transmit or receive a leakage signal from or to the branches subjected to the calibration.

The reference signal may include pseudo-random noise. Reference signals used for different signal transfer measurements may be mutually orthogonal, e.g., with respect to the correlation.

The correlation may be performed in the time domain or (e.g., after a Fast Fourier Transformation block) in the frequency domain.

The ratio (e.g., the ratio minus 1) may be indicative of a deviation between the first antenna element and the second antenna element, e.g., in at least one of amplitude, phase and time delay. The ratio may be complex-valued.

The method and/or the antenna array may be implemented at a radio base station or radio access node of a radio access network; at a user equipment or mobile station connected or connectable to the radio access network; and/or at end points of a radio backhaul link of the radio access network.

As to a further aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download via a data network, e.g., the radio access network and/or the Internet.

As to a hardware aspect, a device for calibrating an antenna array including a plurality of antenna elements is provided. The device is adapted to perform or trigger the step of configuring at least a first antenna element and a second antenna element for a first operating mode, and configuring at least a third antenna element for a second operating mode, wherein the first operating mode includes transmission and the second operating mode includes reception or vice versa; the step of measuring a first signal transfer between the first antenna element and the third antenna element, and measuring a second signal transfer between the second antenna element and the third antenna element; the step of determining a ratio based on the first signal transfer measurement and the second signal transfer measurement; and the step of calibrating the antenna array based on the determined ratio.

The devices may further include any feature disclosed in the context of the method aspect. Particularly, the device may comprise one or more units adapted to perform one or more of the steps of the method aspect.

As to a further hardware aspect, an antenna array is provided. The antenna array comprises a substrate; a plurality of antenna elements arranged on the substrate; and the above device coupled to the plurality of antenna elements. The plurality of antenna elements may be arranged on one surface of the substrate. The device may be arranged on the other surface of the substrate opposite to the one surface.

### BRIEF DESCRIPTION OF THE DRAWINGS

Further details of embodiments of the technique are described with reference to the enclosed drawings, wherein:

FIG. 1 shows a schematic block diagram of a device for calibrating an antenna array;

FIG. 2 shows a flowchart for a method of calibrating an antenna array, which is implementable by the device of FIG. 1;

FIG. 3 shows a schematic block diagram of a first embodiment of an antenna array, which is calibratable by the device of FIG. 1 performing the method of FIG. 2;

FIG. 4 shows a schematic block diagram of a second embodiment of an antenna array, which is calibratable by the device of FIG. 1 performing the method of FIG. 2;

FIG. 5 shows a flowchart for a first implementation of the method of FIG. 2;

FIG. 6 shows a flowchart for a second implementation of the method of FIG. 2;

FIG. 7 shows a flowchart for a third implementation of the method of FIG. 2;

FIG. 8 shows a flowchart for a fourth implementation of the method of FIG. 2;

FIG. 9 shows a schematic block diagram of a third embodiment of an antenna array, which is calibratable by the device of FIG. 1 performing the method of FIG. 2; and

FIG. 10 shows a schematic block diagram of a fourth embodiment of an antenna array, which is calibratable by the device of FIG. 1 performing the method of FIG. 2.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that de-part from these specific details. Furthermore, while the following embodiments are primarily described for Long Term Evolution (LTE), LTE-Advanced and next-generation implementations, the technique may readily be applied to the Global System for Mobile Communications (GSM) and Wideband Code Division Multiple Access (WCDMA) telecommunications, and it is readily apparent that the technique described herein may also be implemented in any other wireless access network, including a Wireless Local Area Network (WLAN) according to the standard family IEEE 802.11 (e.g., IEEE 802.11a, g, n or ac) and/or a Worldwide Interoperability for Microwave Access (WiMAX) according to the standard family IEEE 802.16. Moreover, the technique is applicable to any communication system using Multiple-Input Multiple-Output (MIMO) schemes such as pre-coding matrices or excitation vectors to point transmission power or reception sensitivity of an antenna array in a certain direction (e.g., by means of beamforming).

Moreover, those skilled in the art will appreciate that the services, functions and steps explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising a computer processor and memory coupled to the processor, wherein the memory is encoded with one or more programs that may perform the services, functions and steps disclosed herein.

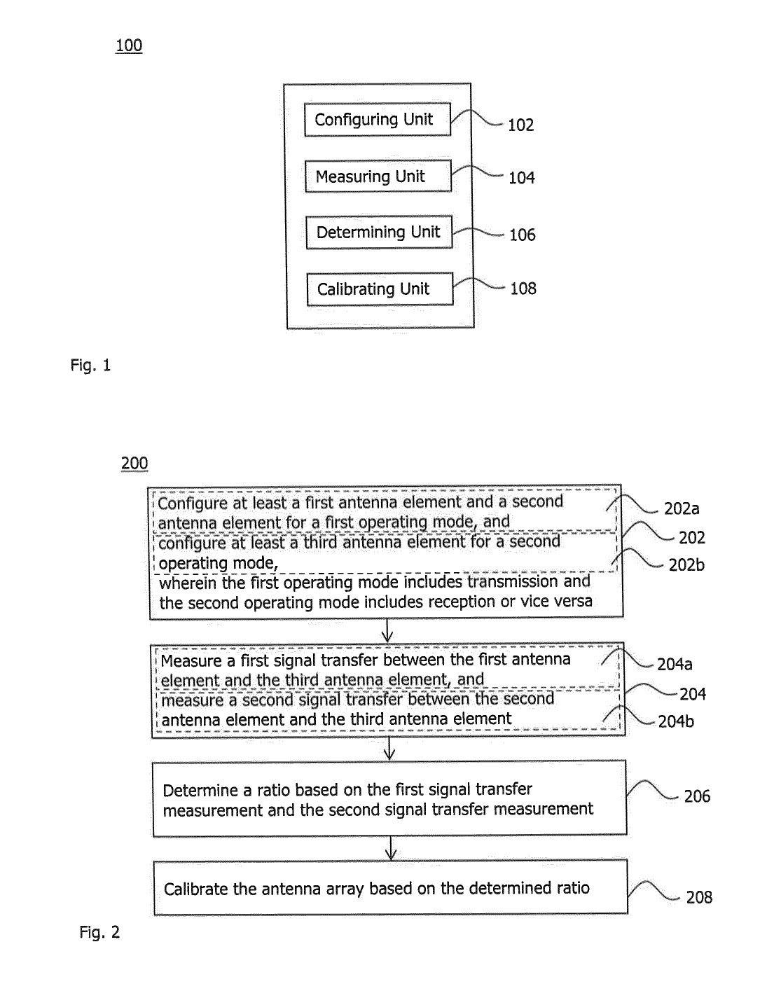

FIG. 1 shows a schematic block diagram of a device 100 for calibrating an antenna array. The device 100 comprises a configuring unit 102 for switching at least three antenna elements of the antenna array into a certain operating state.

The device 100 further comprises a measuring unit 104 for measuring two signal transfers to (or from) a first antenna element and a second antenna element, respectively. The first and second signal transfer measurements are performed in con-junction with a third antenna element that the configuring unit 102 configures and the measuring unit 104 controls for transmitting (or receiving) signals during the measurements.

The device 100 further comprises a determining unit 106 for determining a ratio based on at least the two signal transfer measurements, and a calibrating unit 108 for calibrating the antenna array based on the ratio.

FIG. 2 shows a flowchart for a method 200 of calibrating an antenna array including a plurality of antenna elements. In a step 202 of the method 200, at least three antenna elements are configured. In a substep 202a of the step 202, a first antenna element and a second antenna element are configured for a first operating mode. In a substep 202b of the step 202, at least a third antenna element is configured for a second operating mode. The first operating mode includes transmission and the second operating mode includes reception, or vice versa.

In a step 204 of the method 200, at least two signal transfer measurements are performed. In a substep 204a of the step 204, a first signal transfer measurement for a first signal transfer between the first antenna element and the third antenna element is performed. In a substep 204b of the step 204, a second signal transfer measurement is performed between the second antenna element and the third antenna element.

In a step 206 of the method 200, a ratio is determined based on the first signal transfer measurement and the second signal transfer measurement. The antenna array is calibrated based on the determined ratio in a step 208.

The method 200 may be performed by the device 100. E.g., the units 102 to 108 may perform the steps 202 to 208, respectively.

The technique can be implemented for large antenna arrays, e.g., used in telecommunication systems and in any other systems deploying antenna arrays. The technique allows calibrating amplitude offsets, phase offsets and/or time delays associated with different antenna elements in the antenna array.

The antenna array may be deployed in a wide range of applications, e.g., due to its flexibility in defining a radiation pattern “on-the-fly” and lowering side lobes in directions outside of the defined radiation maximum. The technique is also applicable to any system taking advantage of a multitude of radio branches or spatial layers, e.g., to support MIMO communications or beamforming.

The technique thus allows calibrating a plurality of transmit side-branches and/or a plurality of receive side-branches (associated with the first and second antenna elements) without using extra hardware. Only one or more third antenna elements (and the associated receive or transmit side-branch) is utilized for measuring the signal transfers. The third antenna element (and the associated side-branch) does not substantially influence the resulting ratio, since a gain associated with the third antenna element (and the associated side-branch) cancels out in the determination of the ratio.

The measured signal transfers may also depend on a radio coupling (e.g., radio crosstalk) between the respective pair of antenna elements. The radio coupling for each pair of antenna elements is known, e.g., by a previous measuring. Thus, the gain ratio between each pair of transmit side-branches and/or each pair of receive side-branches is determined. Furthermore, the radio coupling between antenna elements typically remain constant, independently of temperature, aging or any other process which requires calibration, e.g., the calibration in the signal chain or branch associated with each of the antenna elements.

The technique is not limited in terms of a spectral width of a radio communication used by the calibrated antenna array. A practical implementation is to use the same type of signal that the system will operate under, for example an orthogonal frequency-division multiplexing (OFDM) signal, if the antenna array is used for an LTE implementation. The spectral width of such OFDM signals is 20 MHz according to 3GPP LTE standard. The signal transfer measurements may be aggregated over several carriers. In the next-generation access networks (e.g., for a 5G operation), the spectral width may be even 100 MHz, which in turn may be aggregated to several times 100 MHz.

The technique is applicable to a Time Division Duplex (TDD) system. The technique may use an existing receiver structure to work as sensors when transmitting a reference signal (which is also referred to as a calibration signal).

A typical requirement is that TDD switches are capable of switching into receive (Rx) operation during an actual transmit (Tx) operation. That is, equipment or components for Tx and Rx operation have to be sufficiently independent for switching (at least subsequently) the first and second antenna elements in the first operating mode, while the third antenna element is in the second operating mode. In large antenna arrays this is typically the case. For example, the equipment or the components for first and second polarizations may be used in for the first and second operating modes, respectively. The antenna elements in a first polarization state may be used for the first and second antenna elements. The antenna elements in a second polarization state may be used as a calibration transmitter or receiver (i.e., the third antenna element) in the second operating mode.

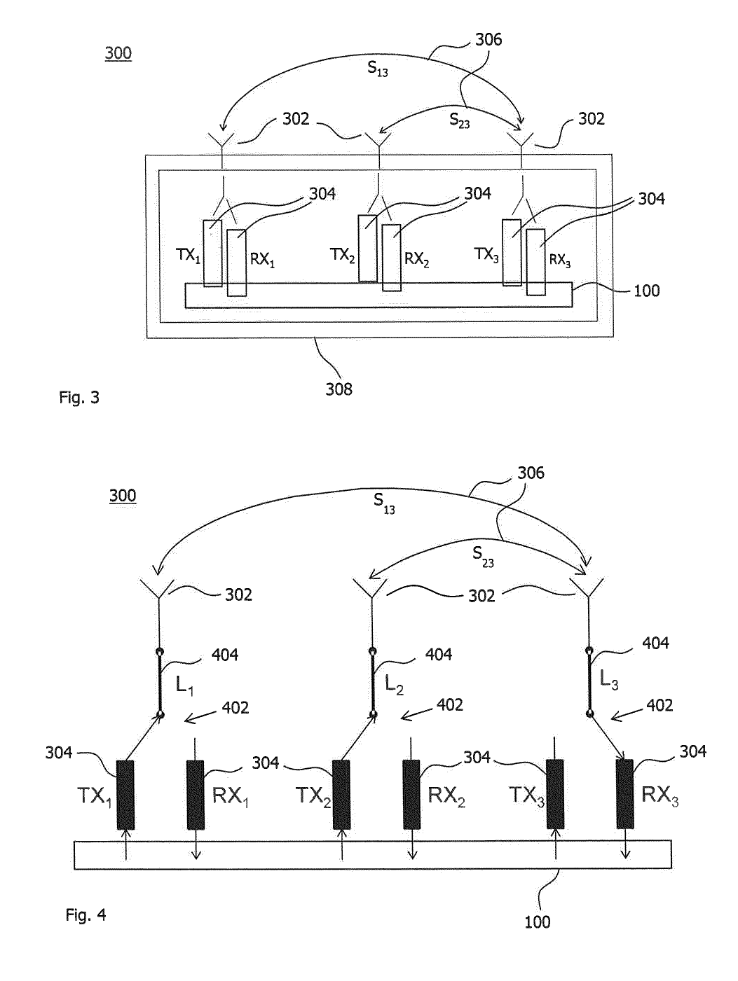

FIG. 3 shows a schematic block diagram for an antenna array 300 comprising at least three antenna elements 302. In the embodiment shown in FIG. 3, each antenna element 302 is associated with a signal chain or branch. The branches may be arranged on a common substrate 308. Each branch comprises a side-branch 304 for transmission (Tx side-branch) and a side-branch 304 for reception (Rx side-branch). Radio couplings 306 between pairs of the antenna elements are exemplarily indicated for the first and third antenna element S₁₃, and for the second and third antenna element S₂₃.

In some embodiments, the radio coupling is without relevance, e.g., because the radio couplings are equal (e.g., due to a symmetric arrangement of the antenna elements). In same or other embodiments, the radio coupling may cancel out in the determined ratio. In other embodiments, a prerequisite is that the radio couplings for antenna elements, or ratios thereof, are known. For example, values for the radio couplings are used to solve linear equations for the ratio between Tx side-branches and/or for relations between Rx side-branches.

In a simple embodiment, the antenna array 300 may have only 3 antenna branches each associated with one of the antenna elements 302, each having two side-branches 304 for Tx and Rx.

The first and second signal transfer measurements (also referred to as loop measurements) may be represented by Eqs. 1 and 2, respectively:

x₁(t)·TX₁·S₁₃·RX₃=y₁(t), and (1)

x₂(t)·TX₂·S₂₃·RX₃=y₂(t), (2)

wherein x₁(t) and x₂(t) are representative of the reference signal (or calibration signal) as transmitted, and y₁(t) and y₂(t) are representative of the reference signal (or calibration signal) as received in the steps 204a and 204b, respectively. TXᵢ and RXᵢ are representative of the gains associated with the i-th antenna element 302 in the Tx and Rx operating mode, respectively.

Correlating each of the two equations, e.g., with x₁(t) for the first signal transfer measurement according to Eq. 1 and with x₂(t) for the second signal transfer measurement according to Eq. 2, results in

[symbol]

x₁(t)*|x₁(t) [symbol] ·TX₁·S₁₃·RX₃= [symbol] x₁(t)*|y₁(t) [symbol] , and (3)

[symbol]

x₂(t)*|x₂(t) [symbol] ·TX₂·S₂₃·RX₃= [symbol] x₂(t)·|y₂(t) [symbol] . (4)

A rearrangement of Eqs. 3 and 4 results in

TX₁·S₁₃·RX₃=a, and (5)

TX₂·S₂₃·RX₃=b, (6)

wherein the correlation values a and b are defined by

$$\begin{matrix}a = \frac{〈 {{x}_{1} ( t )}^{*} \vert {y}_{1} ( t ) 〉}{〈 {{x}_{1} ( t )}^{*} \vert {x}_{1} ( t ) 〉} , and & ( 7 ) \\ b = \frac{〈 {{x}_{2} ( t )}^{*} \vert {y}_{2} ( t ) 〉}{〈 {{x}_{2} ( t )}^{*} \vert {x}_{2} ( t ) 〉} . & ( 8 )\end{matrix}$$

From above Eqs. 5 and 6, a relation between two Tx side-branches is determined in the step 206 according to the ratio

$$\frac{{TX}_{1}}{{TX}_{2}} \cdot \frac{{S}_{13}}{{S}_{23}} = \frac{a}{b} . \qquad ( 9 )$$

Thus, the relation between two Tx side-branches is readily obtained based on the signal transfer measurements 204, e.g., if the radio couplings 306 cancel out or if values for the radio couplings 306 are known.

The values for the radio couplings may be known a priori. The coupling values may be determined at designing the antenna array 300 (e.g., when designing the plurality of antenna elements 302 and their relative position) or may be measured at production (e.g., when the antenna elements 302 are assembled).

The radio couplings are not likely to change during operation of the antenna array 300. A radio coupling matrix (also referred to as antenna coupling matrix or S-matrix) may be stored (e.g., in a flash memory associated with or arranged at the antenna array 300) for a given antenna array 300.

The same type of measurements 204 and determinations 206 may be performed for the Rx side-branches.

The operator < . . . | . . . > defines an inner operator, which may be implemented by computing the correlation between the signals x and y. The correlation values (e.g., the values a and b) may be complex-valued. The above definition of the correlation values is an example for implementing the correlation, which is applicable to all embodiments described herein.

Based on the determined ratio, the necessary compensations for calibration are applied in the step 208. Each antenna element 302 may be associated with a radio branch. Each radio branch may include, or may be associated with, an analog phase shifter and/or an analog attenuator, e.g. in an analog antenna array 300. A digital antenna array 300 may be configured for being fed at each branch individually by a digital signal (e.g., provided by a digital transceiver). For the digital antenna array 300, phase and/or amplitude compensation may performed directly in the digital domain, e.g., at a baseband component.

The calibration method 200 may be based on the stored antenna coupling matrix indicating the couplings 306. It is not necessary to store the full S-matrix of the antenna structure (i.e., the radio coupling value for each combination of antenna element pairs). For example, it may be sufficient to store the values S_{xy} for the radio couplings 306 for x<y (e.g., without values Sₓₓ for reflection coefficients). That is, it may be sufficient to know how much of the reference signal that is transmitted from or to the third antenna element to or from another antenna element (given the antenna array 300). But it is not necessarily to know the reflection coefficients.

In an embodiment, one or a few third antenna elements are selected for all signal transfer measurements 206 performed for calibrating the entire antenna array 300.

The stored values may be limited to those radio couplings relative to the one or a few third antenna elements. Thus, a number of stored values for the radio couplings 306 and/or a number of signal transfer measurements 204 may scale linearly with the number of antenna elements 302 in the antenna array 300.

FIG. 4 schematically illustrates a more detailed embodiment of the antenna array 300. Like reference signs indicate features corresponding to those of the embodiments shown in FIGS. 1 and 3. If the antenna array 300 is configured for regular TDD communications, it is assumed that TDD switches 402 can be scheduled to switch one or more branches of the antenna array 300 to the operating mode for reception in time slots dedicated for the operating mode of transmission.

Optionally, the individual radio branches are attenuated or decoupled in such a way so as to minimize a disturbance of other antenna branches involved in the calibration method 200. This is achieved, e.g., by biasing or setting power amplifiers (PA) in their OFF-state.

Moreover, the reference signal that is used for the signal transfer is preferably attenuated, e.g., at a baseband chip or a baseband component. A sufficient attenuation avoids overloading a receiver or a Rx side-branch involved in the signal transfer measurements. The receiver or Rx side-branch is configured for much lower input power levels, e.g., as received from a regular communication peer, than the power levels used for a regular transmit operation.

A number of measurements (also referred to as iterations) may be performed in order to obtain a set of signal transfer measurements (e.g., correlation coefficients), from which the sought relations between any antenna element pair may be retrieved according to the step 206. Based thereon, the entire antenna array is calibrated according to the step 208.

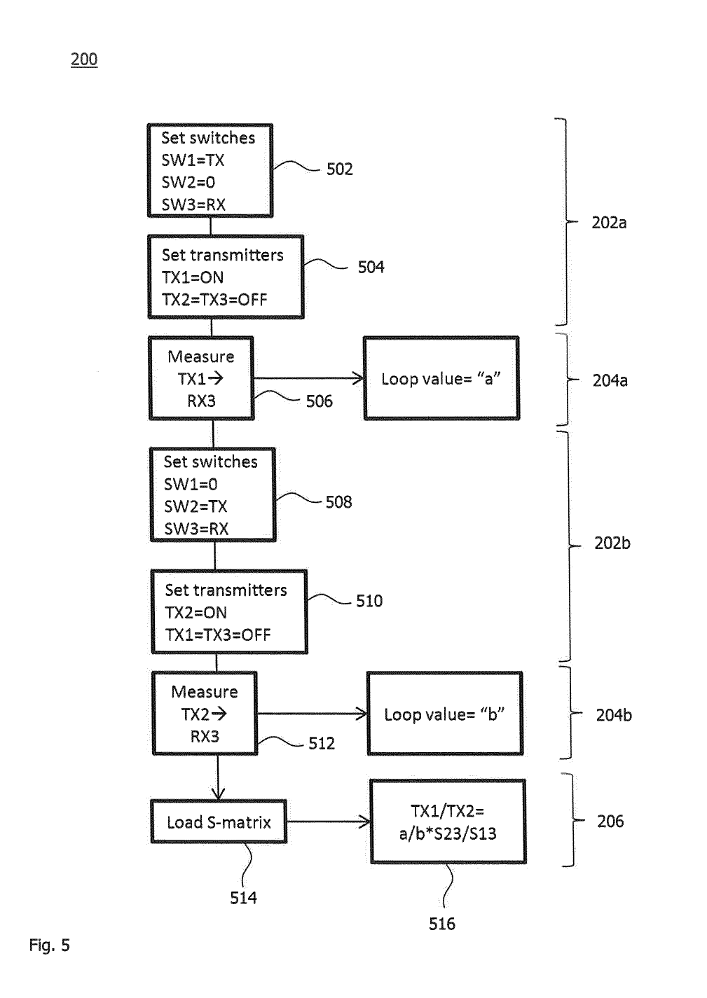

More detailed implementations of the calibration method 200 are described with reference to FIGS. 5 to 8. The steps 202 to 206 may be repeated or iterated for different combinations of the antenna elements 302 involved in the signal transfer measurements.

FIG. 5 shows a flowchart for a first iteration for determining a first Tx ratio.

The side-branch switches 402 may be set so that antenna element 1 (as the first antenna element) is configured for transmission and antenna element 3 (as the third antenna element) is configured for reception, which is indicated at reference sign 502, in the substep 202a. The substep 202a further includes enabling the transmitter for the antenna element 1 and disabling the transmitter for the antenna element 3, as shown at reference sign 504. Optionally, the side-branch switch for the antenna element 2 (as the second antenna element) is set to an open state for decoupling the second antenna element from the first and third antenna elements involved in the first signal transfer measurement, which is indicated at reference sign 506. The transmitter associated with the antenna element 2 is also disabled in the step 202a.

The first signal transfer measurement 204a yields a first correlation coefficient a.

The side-branch switches 402 may be set so that antenna element 2 (as the second antenna element) is configured for transmission and antenna element 3 (as the third antenna element) is configured for reception, which is indicated at reference sign 508, in the substep 202b. The substep 202b further includes enabling the transmitter for the antenna element 2 and disabling the transmitter for the antenna element 3, as shown at reference sign 510. Optionally, the side-branch switch for the antenna element 1 (as the first antenna element) is set to an open state for decoupling the first antenna element from the second and third antenna elements involved in the second signal transfer measurement, which is indicated at reference sign 512. The transmitter associated with the antenna element 1 is also disabled in the step 202b.

The second signal transfer measurement 204b yields a second correlation coefficient b.

Based on the first and second correlation coefficients, and the stored values for the radio couplings 306 retrieved at reference sign 514, the ratio for the Tx side-branches is determined at reference sign 516 according to the step 206.

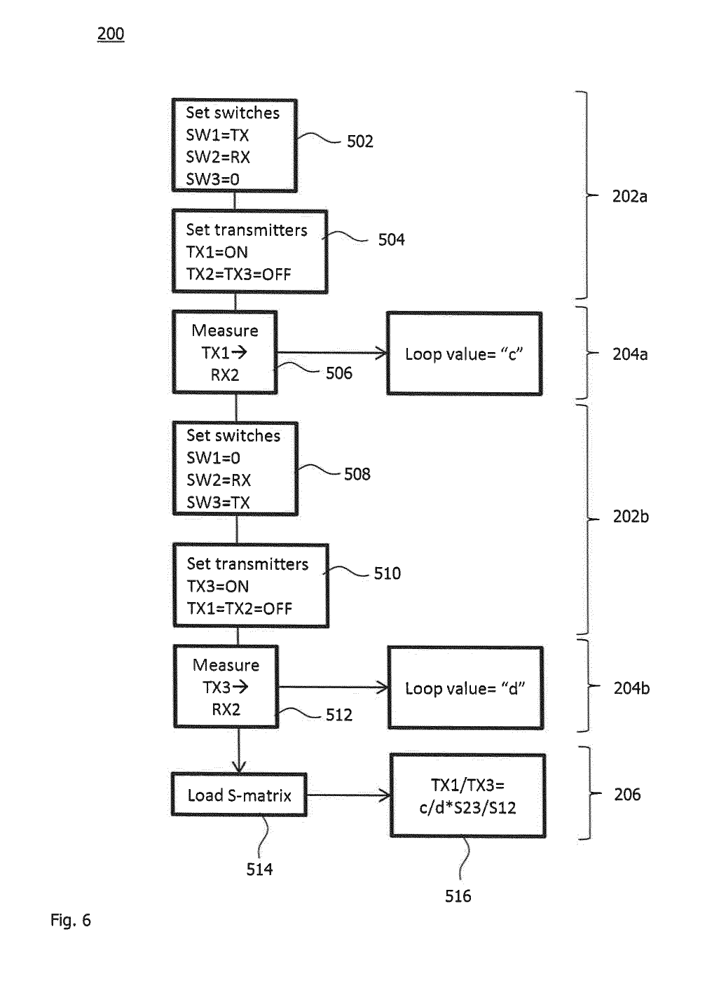

FIG. 6 shows a flowchart for a second iteration for determining a second Tx ratio. Like reference signs indicate steps corresponding to those of the first iteration shown in FIG. 5. The antenna element 1 functions as the first antenna element, the antenna element 2 functions as the third antenna element, and the antenna element 3 functions as the second antenna element.

It is not necessary to determine a third Tx ratio between the antenna elements 2 and 3 by further measurements, since the first Tx ratio between antenna elements 1 and 2 and the second Tx ratio between antenna elements 1 and 3 implies such a third ratio.

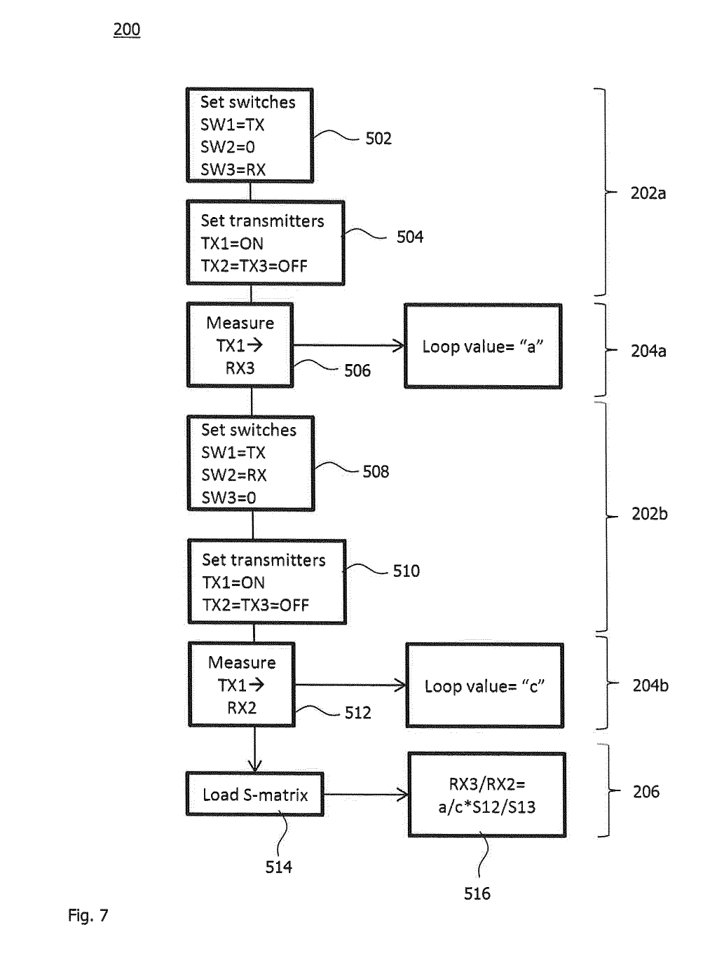

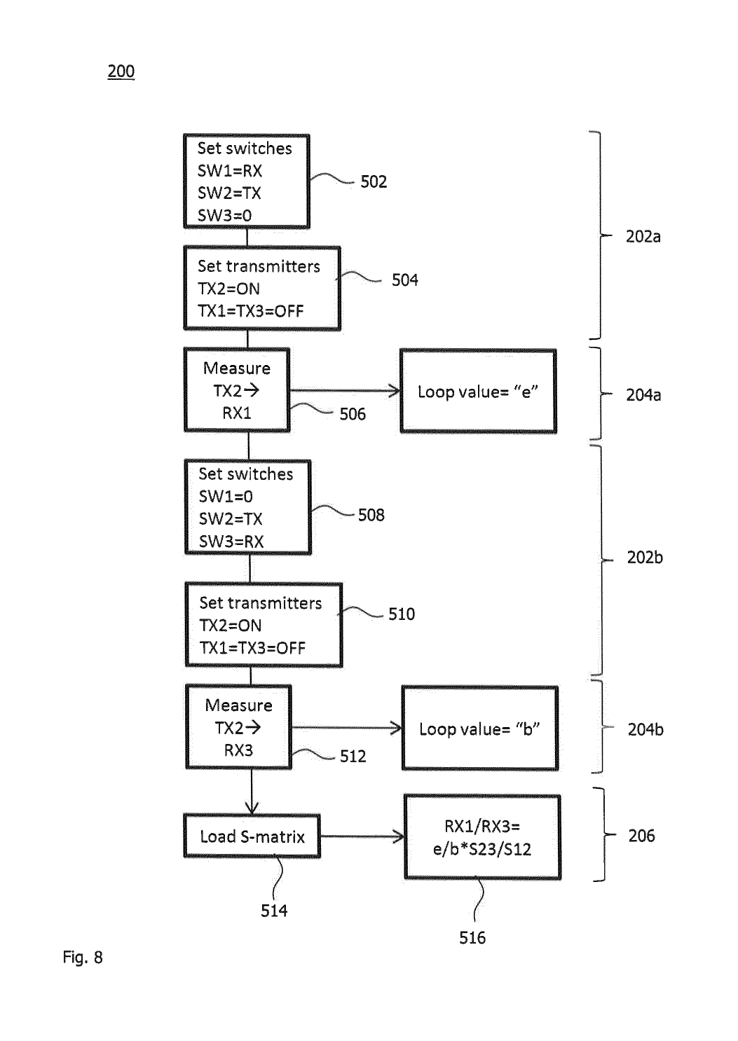

While the implementations discussed with reference to FIGS. 5 and 6 configure the first operating mode for transmission and the second operating mode for reception, the iterations shown in FIGS. 7 and 8 configure the first operating mode for reception and the second operating mode for transmission.

FIG. 7 shows a flowchart for a third iteration for determining a first Rx ratio.

The side-branch switches 402 may be set so that antenna element 3 (functioning as the first antenna element) is configured for reception and antenna element 1 (functioning as the third antenna element) is configured for transmission, which is indicated at reference sign 502, in the substep 202a. The substep 202a further includes enabling the transmitter for the antenna element 1 and disabling the transmitter for the antenna element 3, as shown at reference sign 504. Optionally, the side-branch switch for the antenna element 2 (functioning as the second antenna element) is set to an open state for decoupling the second antenna element from the first and third antenna elements involved in the first signal transfer measurement, which is indicated at reference sign 506. The transmitter associated with the antenna element 2 is also disabled in the step 202a.

The first signal transfer measurement 204a yields a first correlation coefficient a. Clearly, the substeps 202a and 204a can be omitted, if the corresponding substeps have been previously performed in the first iteration.

The side-branch switches 402 may be set so that antenna element 2 (functioning as the second antenna element) is configured for reception and antenna element 1 (functioning as the third antenna element) is configured for transmission, which is indicated at reference sign 508, in the substep 202b. The substep 202b further includes enabling the transmitter for the antenna element 1 and disabling the transmitter for the antenna element 2, as shown at reference sign 510. Optionally, the side-branch switch for the antenna element 3 (functioning as the first antenna element) is set to an open state for decoupling the first antenna element from the second and third antenna elements involved in the second signal transfer measurement, which is indicated at reference sign 512. The transmitter associated with the antenna element 3 is also disabled in the step 202b.

The second signal transfer measurement 204b yields a second correlation coefficient c.

Based on the first and second correlation coefficients, and the stored values for the radio couplings 306 retrieved at reference sign 514, the ratio for the Rx side-branches is determined at reference sign 516 according to the step 206.

FIG. 8 shows a flowchart for a fourth iteration for determining a second Rx ratio. Like reference signs indicate steps corresponding to those of the third iteration shown in FIG. 7. The antenna element 1 functions as the first antenna element, the antenna element 2 functions as the third antenna element, and the antenna element 3 functions as the second antenna element.

A variant of the first and second iterations for transmission calibration illustrated in FIGS. 5 and 6 uses a further gain Lⱼ common to both transmit and receive side-branches, as is represented by means of Eqs. 10 and 11, respectively:

$$\begin{matrix}\begin{matrix}a = {TX}_{1} \cdot {L}_{1} \cdot {S}_{13} \cdot {L}_{3} \cdot {RX}_{3} \\ b = {TX}_{2} \cdot {L}_{2} \cdot {S}_{23} \cdot {L}_{3} \cdot {RX}_{3}\end{matrix} \frac{a}{b} = \frac{{TX}_{1} \cdot {L}_{1}}{{TX}_{2} \cdot {L}_{2}} \cdot \frac{{S}_{13}}{{S}_{23}} & ( 10 ) \\ \begin{matrix}c = {TX}_{1} \cdot {L}_{1} \cdot {S}_{12} \cdot {L}_{2} \cdot {RX}_{2} \\ d = {TX}_{3} \cdot {L}_{3} \cdot {S}_{23} \cdot {L}_{2} \cdot {RX}_{2}\end{matrix} \frac{c}{d} = \frac{{TX}_{1} \cdot {L}_{1}}{{TX}_{3} \cdot {L}_{3}} \cdot \frac{{S}_{12}}{{S}_{23}} & ( 11 ) \\ \begin{matrix}e = {TX}_{2} \cdot {L}_{2} \cdot {S}_{12} \cdot {L}_{1} \cdot {RX}_{1} \\ f = {TX}_{3} \cdot {L}_{3} \cdot {S}_{13} \cdot {L}_{1} \cdot {RX}_{1}\end{matrix} \frac{e}{f} = \frac{{TX}_{2} \cdot {L}_{2}}{{TX}_{3} \cdot {L}_{3}} \cdot \frac{{S}_{12}}{{S}_{13}} & ( 12 )\end{matrix}$$

It is evident from Eq. 10 that, if the ratio of the two values S₁₃ and S₂₃ for the radio couplings 306 (and not necessarily the individual values for the radio couplings 306) are known, the ratio (Tx₁L₁)/(Tx₂L₂) of the two transmit chains 1 and 2 can be readily calculated. Likewise, according to Eq. 11, or using Eqs. 10 and 12, the ratio

(TX₁L₁)/(TX₃L₃)

can be calculated.

Herein, the further gain Lⱼ in the signal chain or branch associated with the j-th antenna element and common to both the Rx and the Tx side-branches is factored out of the gain to be represented by the ratio. The further gain Lⱼ may be caused by a component 404 for impedance matching and/or a certain length of an antenna feed line (e.g., due to geometrical constraints for arranging the plurality of antenna elements 302). The component 404 may have a defined complex gain value Lⱼ that is optionally not adjustable, e.g., not adjustable for the calibration 208. The impedance matching component 404 may be an inductivity.

The calibration technique can account for any additional imbalances b, e.g., due to different lengths in the feed lines. A reference plane is defined by the a priori knowledge of the antenna coupling matrix. The radio coupling matrix is defined so as to represent the reference plane.

As pointed out above, it is sufficient to perform the measurement 204 and the determination 206 only for two out of above the three Eqs. 10 to 12, since the third ratio directly derives as a ratio or product between the first ratio and the second ratio. By way of example, dividing the results of the first iteration by the result of the second iteration (according to Eqs. 10 and 11, respectively),

((TX₁L₁)/(TX₂L₂))/((TX₁L₁)/(TX₃L₃)),

results in

(TX₃L₃)/(TX₂L₂).

A variant of the third and fourth iterations for reception calibration illustrated in FIGS. 7 and 8 uses the further gain L₁ common to both transmit and receive side-branches, as is represented by means of Eqs. 13 and 14, respectively:

$$\begin{matrix}\begin{matrix}a = {TX}_{1} \cdot {L}_{1} \cdot {S}_{13} \cdot {L}_{3} \cdot {RX}_{3} \\ c = {TX}_{1} \cdot {L}_{1} \cdot {S}_{12} \cdot {L}_{2} \cdot {RX}_{2}\end{matrix} \frac{a}{c} = \frac{{RX}_{3} \cdot {L}_{3}}{{RX}_{2} \cdot {L}_{2}} \cdot \frac{{S}_{13}}{{S}_{12}} & ( 13 ) \\ \begin{matrix}e = {TX}_{2} \cdot {L}_{2} \cdot {S}_{12} \cdot {L}_{1} \cdot {RX}_{1} \\ b = {TX}_{2} \cdot {L}_{2} \cdot {S}_{23} \cdot {L}_{3} \cdot {RX}_{3}\end{matrix} \frac{e}{b} = \frac{{RX}_{1} \cdot {L}_{1}}{{RX}_{3} \cdot {L}_{3}} \cdot \frac{{S}_{12}}{{S}_{23}} & ( 14 ) \\ \begin{matrix}d = {TX}_{3} \cdot {L}_{3} \cdot {S}_{23} \cdot {L}_{2} \cdot {RX}_{2} \\ f = {TX}_{3} \cdot {L}_{3} \cdot {S}_{13} \cdot {L}_{1} \cdot {RX}_{1}\end{matrix} \frac{d}{f} = \frac{{RX}_{2} \cdot {L}_{2}}{{RX}_{1} \cdot {L}_{1}} \cdot \frac{{S}_{23}}{{S}_{13}} & ( 15 )\end{matrix}$$

Likewise for reception calibration, the ratio (RX₂L₂)/(RX₁L₁) in Eq. 15 may also be obtained from the ratios in Eqs. 13 and 14. Alternatively or in addition, the ratio in Eq. 15 is obtained according to the steps 202 to 206, e.g., if the ratio S₂₃/S₁₃ between the radio coupling values is known.

Above implementations accord to Eqs. 1 to 9 and/or Eqs. 10 to 15 have been described for clarity. The technique may also be embodied using a more complex representation of the signal transfer measurements 204 and/or a larger number of the antenna elements 302. The number of iterations may scale linearly with the number of the antenna elements 302.

As schematically indicated in FIG. 4, the switches 402 are set according to the measurement configurations in the step 202. If constraints prevent certain configurations (and thereby certain iterations), a minimal set of iterations may be performed, e.g., according to a scheme for traversing the antenna elements 302, so that all other ratios can be derived from those ratios determined in the step 206 based on the measurements 204. In a first example, constraints may be caused by the switches 402 being configured for a TDD communication. In a second example (combinable with the first example), Tx side-branches 304 and Rx side-branches 304 are bundled in Tx and Rx groups, respectively, so as to have radio components in common, in which case the switches 402 cannot be set freely but have to comply with the bundling groups.

In the case of a minimal set of available configurations (and thus iterations) being not sufficient (e.g., due to the constraints), or in other cases, a second polarization can be utilized. For example, the radio components associated with two different polarizations are independent, i.e., antenna elements for different polarizations can be configured independently, e.g., without constraints due to the bundling groups.

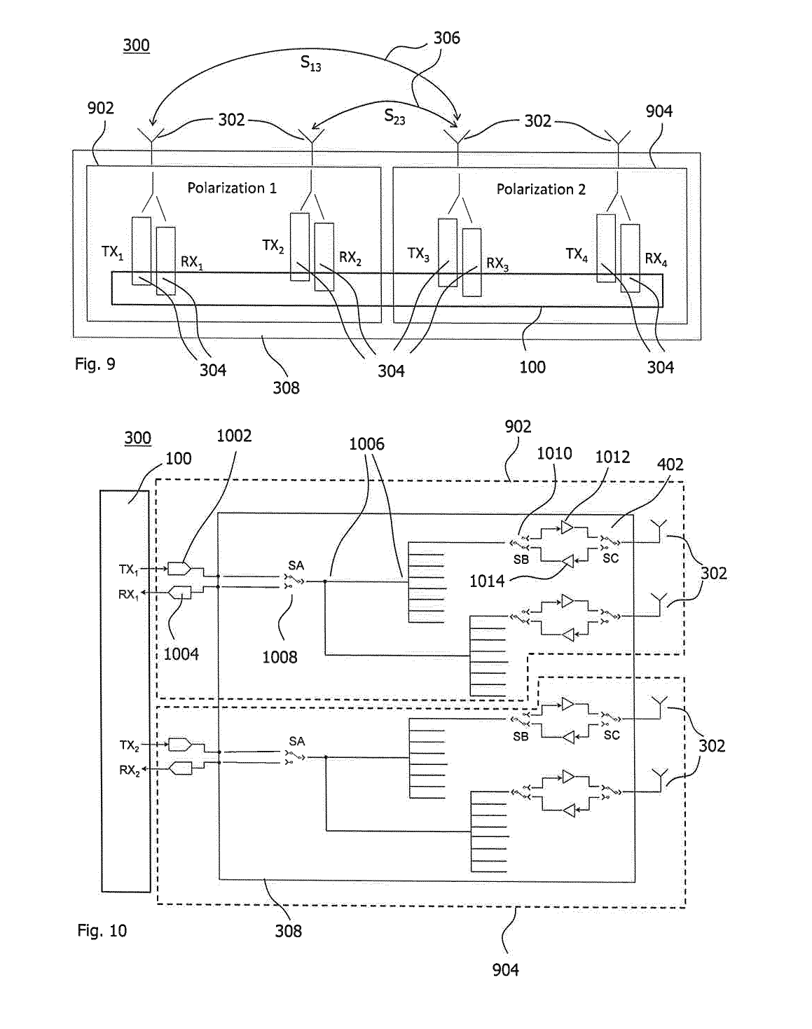

FIG. 9 illustrates a schematic block diagram for a third embodiment of the antenna array 300 that is configured for a radio communication using different polarizations. Four antenna elements 302 and associated antenna branches are illustrated for clarity. The third embodiment is readily extendable to a multitude of antenna branches.

Each antenna branch is split into two polarizations (labelled polarization 1 and polarization 2). The different polarizations 1 and 2 may be linear polarizations or combinations thereof, for example a Right Hand Circular Polarization (RHCP) or a Left Hand Circular Polarization (LHCP). Components associated with the polarizations 1 and 2 are arranged in separate blocks 902 and 904, respectively, e.g., on a common substrate 308.

In one iteration, the polarization 1 is calibrated in the Tx direction. That is, the first operating mode includes transmission. The first and second antenna elements are selected from the block 902 for the polarization 1. Labeling antenna ports from left (port 1) to right (port 4) in FIG. 9, a transmitting port 1 (also referred to as an exciting port) is configured for antenna element 1, and a receiving port 3 is configured for antenna element 3 in the substep 202a. Furthermore, a transmitting port 2 is configured for antenna element 2. The configuration for the receiving port 3 is maintained or reset in the substep 202b.

The first and second signal transfer measurements 204 are represented by

TX₁·S₁₃·RX₃=a, and (16)

TX₂·S₂₃·RX₃=b, respectively. (17)

The first and second signal transfer measurements 204 directly provide the ratio TX₁/TX₂ according to the determining step 206:

$$\frac{{TX}_{1}}{{TX}_{2}} \cdot \frac{{S}_{13}}{{S}_{23}} = \frac{a}{b} . \qquad ( 18 )$$

Configuring the antenna array 300 according to the step 202 for the measurements 204 may also be referred to as calibration functionality.

FIG. 10 schematically illustrates a block diagram for a fourth embodiment of the antenna array 300. The fourth embodiment is a one-chip implementation of the third embodiment configured for two polarizations. Like reference signs indicate corresponding features. The antenna ports are labeled from top (port 1) to bottom (port 4) in FIG. 10. The fourth embodiment of the antenna array 300 comprises a digital-to-analog converter 1002 and an analog-to-digital converter 1004 in the Tx and Rx branches, respectively.

In the third and fourth embodiments, all transmission side-branches 304 (also referred to as transmission paths) that are not involved in the current signal transfer measurements 204a or 204b can be set as low as necessary to avoid interference from such other side-branches 304.

In one implementation, the branches associated with antenna elements 302 not involved in the signal transfer measurements are set to an inoperative state, e.g., an OFF state or a high-impedance state. The inoperative state is suited, e.g., for an antenna array 300 configured for analog beam forming, i.e., for an antenna array 300 not including a digital interface for every branch. Rather, the signal for different antenna elements 302 may be split on an analog RF level, e.g., at branching points 1006. In the one implementation, it is possible to set the state individually for the different amplifiers 1012 and 1014, e.g., by means of the switches SB and SC, respectively, shown at reference signs 1010 and 402 in FIG. 10.

The gain caused by a signal chain associated with each of the antenna elements is directionally asymmetric, since Tx side-branch and Rx side-branch include components that cannot be reversed to work in both forward and backward directions. For example, the Power Amplifiers (PA) 1012 and the Low Noise Amplifiers (LNA) 1014 are typically distinct components.

The fourth embodiment of the antenna array 300 shown in FIG. 10 is configured for two polarizations. The Tx and Rx operating modes partially use the same analog hardware components, e.g., the branching points 1006. It is evident from FIG. 10 that the receiver components cannot be switched individually for the antenna elements 302 (e.g., those downstream of the same branching point 1006) during the calibration method 200 by means of the switch SA shown at reference sign 1008 in FIG. 10.

A set of separate radio chains is utilized for the first and second operating modes, e.g., based on parallel hardware components available for the different (e.g., orthogonal) polarizations 1 and 2. In the embodiments shown in FIGS. 9 and 10, the different polarizations 1 and 2 are implemented by independent hardware blocks 902 and 904. While one or more radio chains in the block 902 are used for configuring the first and second antenna elements 302, a separate radio chain in the block 904 is used for configuring the third antenna element.

Optionally, within the hardware block 902 dedicated for the polarization 1, the side-branches Tx1 and Rx1 may define a first bundling group, and the side-branches Tx2 and Rx2 may define a second bundling group. Similarly, the side-branches Tx3 and Rx3 may define a first bundling group, and the side-branches Tx4 and Rx4 may define a second bundling group.

In the fourth embodiment shown in FIG. 10, at least the three switches 402, 1008 and 1010 are also used for normal TDD switching. By settings the switches SA, SB and SC properly, the reference signal is transferred according to the configuration 202 for the measurements 204 (which is also referred to as a loop-around signaling), e.g., in accordance with above Eqs. 10 to 15.

In the Tx calibration for the polarization 1, the configuring step 202 sets the switches illustrated in FIG. 10 in the following manner:

(Switch Configuration for Calibrating Tx Side-Branches of Polarization 1)

SA=SB=SC=TX for polarization 1

SA=SB=SC=RX for polarization 2

For the Tx calibration of antenna elements 302 associated with polarization 2, two reverse measurements 204 are performed. That is, a first signal transfer measurement 204 is performed from port 3 (in the block 904) into port 1 (in the block 902), and a second signal transfer measurement is performed from port 4 (in the block 904) into the same port 1 (in the block 902). The first and second measurements are representable by

TX₃·S₁₃·RX₁=c, and (19)

TX₄·S₁₄·RX₁=d, respectively. (20)

The two measurements immediately provide the TX₃/TX₄ relation in the step 206 according to

$$\frac{{TX}_{3}}{{TX}_{4}} \cdot \frac{{S}_{13}}{{S}_{14}} = \frac{c}{d} . \qquad ( 21 )$$

The settings for the switches configured in the step 202 for the TX calibration of the polarization 2 include:

(Switch Configuration for Calibrating Tx Side-Branches of Polarization 2)

SA=SB=SC=RX for polarization 1

SA=SB=SC=TX for polarization 2

For the Rx calibration of the polarization 2, port 1 (in the block 902) is configured for transmission and port 3 (in the block 904) is configured for reception in the substep 202a. The corresponding signal transfer measurement 204a corresponds to the one of Eq. (16), rewritten here for convenience:

TX₁·S₁₃·RX₃=a. (22)

Subsequently, port 4 (in the block 904) is configured for reception in the substep 202b. When transmitting at port 1 (in the block 902), the signal transfer measurement 204b is representable by:

TX₁·S₁₄·RX₄=e. (23)

From the first and second signal transfer measurements representable by the two Eqs. (22) and (23), the ratio is determined in the step 206 for the polarization 2:

$$\frac{{RX}_{3}}{{RX}_{4}} \cdot \frac{{S}_{13}}{{S}_{14}} = \frac{a}{e} \qquad ( 24 )$$

The switches set by the configuring substep 202b for the Rx calibration of the polarization 2 include:

(Switch Configuration for Calibrating Rx Side-Branches of Polarization 2)

SA=SB=SC=TX for polarization 1

SA=SB=SC=RX for polarization 2

For the Rx calibration of the polarization 1, the following first and second signal transfer measurements 204 are performed:

TX₃·S₁₃·RX₁=ƒ, and (25)

TX₃·S₂₃·RX₂=g. (26)

The sought ratio between Rx₁/Rx₂ is readily determined in the step 206 according to:

$$\frac{{RX}_{1}}{{RX}_{2}} \cdot \frac{{S}_{13}}{{S}_{23}} = \frac{f}{g} . \qquad ( 27 )$$

The configuring step 202 for the Rx calibration of the polarization 1 includes setting the switches according to:

(Switch Configuration for Calibrating Rx Side-Branches of Polarization 1)

SA=SB=SC=RX for polarization 1

SA=SB=SC=TX for polarization 2

The above equations and implementations are based purely on measurements using couplings “over the air”, optionally across different polarizations, which readily gives at least in these particular implementations the sought ratios to find every combination of Tx-Tx ratio or Rx-Rx ratio.

One embodiment, compatible with each of above embodiments, is configured for calibrating a digital array antenna 300, i.e., each of the radio branches in the antenna array 300 is configurable for transmitting signals independently, e.g., using a dedicated radio branch. A regular radio communication that individually controls the antenna elements 302 may also be referred to as digital beamforming. The configuring step 202 controls the antenna branches associated with the antenna elements 302 according to the first operating mode, the second operating mode and/or the inoperative mode.

Another embodiment, which may be an extension or variant of the one embodiment, is applicable to analog beam forming. In this case, an independent transmission for one or more antenna elements 302 (i.e., through one or more specific antenna branches) and an independent reception for one or more antenna elements 302 (i.e., on one or more specific antenna branches) is configured in the step 202 by switching-off transmitters in combination with isolating those receive branches that are not involved in the current signal transfer measurement 206.

In a further embodiment, e.g., based on above another embodiment, partly the same radio hardware is used for the transmit part and the receive part. By way of illustration, mixers, phase shifters and/or attenuators may be used in both the Tx branch and the Rx branch. In this case, the calibration may be scheduled for another set of Tx branches that can be operated independently of the branches subjected to the calibration. The second set of Tx branches may be associated with a second polarization different from a first polarization associated with the branches under calibration. Such a second polarization is typically available in system configured for beamforming or MIMO communications.

Tx branches may be downlink branches. Rx branches may be uplink branches.

As has become apparent from above description of exemplary embodiments, at least some embodiments allow determining ratios between any pair of antenna elements in an antenna array. The plurality of branches (or side-branches) is also referred to as a calibration network. The calibration network can be calibrated according to a scheme, e.g., so that the number of configurations and/or measurements scales linearly with the number of antenna elements.

It is not necessary to determine absolute values for the gains of the side-branches. The calibration may be solely based on the ratios of the side-branches.

The technique can be implemented without extra hardware (such as couplers and/or a calibration network for distributing a signal to every transmit branch and every receive branch in the antenna array). The technique can reduce or completely avoid extra RF hardware, e.g., in the form of couplers and switches. For this or further reasons, the technique is more cost-efficient and/or reduces system complexity com-pared to existing calibration techniques.

The method may be performed using additional measurement paths “over the air” (OTA). The technique may exploit a certain amount of radio coupling between antenna elements in an antenna array. The radio coupling may provide an opportunity for additional OTA measurements.

It is not necessary to store a complete radio coupling matrix for all pairs of antenna elements. At least in some embodiments, the radio couplings are effectively cancelled out.

The calibration can align the plurality of antenna elements with respect to phase, amplitude and/or time delay. As a consequence, radiation power can be focused sharper in one specific direction. Interference caused or experienced by the radio communication can be reduced. Alternatively or in addition, the radio communication transmission can be more energy-efficient.

The technique can be implemented for TDD systems, e.g., without additional hardware. The technique may be applicable to any communication system, wherein receive side-branches are used (or are usable) at the same frequency as the transmit side-branches. For FDD systems, the receive side-branches may be re-tuned for matching the transmit frequency during signal transfer measurements.

Measurement equations can be immediately used to calculate imbalances in phase, amplitude and/or time delay among the radio branches associated with the antenna elements. The technique may be repeated for several carrier frequencies, e.g. for a broadband implementation.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-23. (canceled)

24. A method of calibrating an antenna array, the antenna array comprising a plurality of antenna elements, the method comprising:
configuring at least a first antenna element and a second antenna element for a first operating mode, and configuring at least a third antenna element for a second operating mode, wherein the first operating mode includes transmission and the second operating mode includes reception or vice versa;
measuring a first signal transfer between the first antenna element and the third antenna element, and measuring a second signal transfer between the second antenna element and the third antenna element;
determining a ratio based on the first signal transfer measurement and the second signal transfer measurement; and
calibrating the antenna array based on the determined ratio.

25. The method of claim 24, wherein other antenna elements of the antenna array are in a muted state, a grounded state, or a high-impedance state during each signal transfer measurement.

26. The method of claim 24, wherein the signal transfer measurements are performed for each of the plurality of antenna elements.

27. The method of claim 26, wherein each of the plurality of antenna elements functions at least once as the first antenna element or the second antenna element.

28. The method of claim 26, wherein the signal transfer measurements are performed by traversing the plurality of antenna elements according to a predefined scheme so that each antenna element functions once as the first antenna element, the scheme further specifying the second and third antenna elements for each antenna element functioning as the first antenna element.

29. The method of claim 24, wherein at least one of the second antenna element and the third antenna element is adjacent to the first antenna element in the antenna array.

30. The method of claim 24:
wherein the antenna array is coupled to a transceiver for Time Division Duplex (TDD) communication; and
wherein the signal transfer measurements include scheduling transmission and reception for the same time.

31. The method of claim 24:
wherein the antenna array is coupled to a transceiver for Frequency Division Duplex (FDD) communication; and
wherein the signal transfer measurements include tuning transmission and reception to the same frequency.

32. The method of claim 30, wherein a power of the transmission for the signal transfer measurements is less than half of a transmit power for the duplex communication.

33. The method of claim 24, wherein the first and second antenna elements are configured for a first polarization, and the third antenna element is configured for a second polarization that is different from the first polarization.

34. The method of claim 24, wherein the determined ratio is representative of a ratio between a first gain associated with the first antenna element and a second gain associated with the second antenna element.

35. The method of claim 34, wherein the determination of the ratio is further based on a first radio frequency coupling between the first and third antenna elements, and on a second radio frequency coupling between the second and third antenna elements.

36. The method of claim 35, wherein values for the first and second radio frequency couplings are retrieved from memory.

37. The method of claim 34, wherein each signal transfer measurement includes transmitting a reference signal by the antenna element configured for transmission.

38. The method of claim 37, wherein each signal transfer measurement includes receiving the reference signal by the antenna element configured for reception.

39. The method of claim 38, wherein each signal transfer measurement includes correlating the transmitted reference signal and the received reference signal.

40. The method of claim 39:
wherein the determination of the ratio is further based on a first radio frequency coupling between the first and third antenna elements, and on a second radio frequency coupling between the second and third antenna elements;
wherein the ratio is determined according to g₁/g₂=(S₂₃/S₁₃×C₁/C₂), wherein g₁ is representative of the first gain, g₂ is representative of the second gain, S₁₃ is representative of the first radio frequency coupling, S₂₃ is representative of the second radio frequency coupling, c₁ results from the correlation of the first signal transfer measurement, and c₂ results from the correlation of the second signal transfer measurement.

41. The method of claim 37, wherein the reference signal includes pseudo-random noise.

42. The method of claim 24, wherein the ratio is indicative of a deviation between the first antenna element and the second antenna element in at least one of amplitude, phase, and time delay.

43. The method of claim 24, wherein the ratio is complex-valued.

44. A non-transitory computer readable recording medium storing a computer program product for calibrating an antenna array, the antenna array comprising a plurality of antenna elements, the computer program product comprising software instructions which, when run on processing circuitry of a computing device, causes the computing device to:
configure at least a first antenna element and a second antenna element for a first operating mode, and configure at least a third antenna element for a second operating mode, wherein the first operating mode includes transmission and the second operating mode includes reception or vice versa;
measure a first signal transfer between the first antenna element and the third antenna element, and measuring a second signal transfer between the second antenna element and the third antenna element;
determine a ratio based on the first signal transfer measurement and the second signal transfer measurement; and
calibrate the antenna array based on the determined ratio.

45. A device for calibrating an antenna array, the antenna array comprising a plurality of antenna elements, the device comprising:
processing circuitry;
memory containing instructions executable by the processing circuitry whereby the device is operative to:
configure at least a first antenna element and a second antenna element for a first operating mode, and configure at least a third antenna element for a second operating mode, wherein the first operating mode includes transmission and the second operating mode includes reception or vice versa;
measure a first signal transfer between the first antenna element and the third antenna element, and measuring a second signal transfer between the second antenna element and the third antenna element;
determine a ratio based on the first signal transfer measurement and the second signal transfer measurement; and
calibrate the antenna array based on the determined ratio.
